(19) United States
(12) Patent Application Publication
(10) Pub. No.: US 2021/0240027 A1
(43) Pub. Date: Aug. 5, 2021

(54) LIQUID CRYSTAL CELLS

(71) Applicant: Flexenable Limited, Cambridge (GB)

(72) Inventors: Barry Wild, Cambridge (GB); William Reeves, Cambridge (GB)

(21) Appl. No.: 17/161,940

(22) Filed: Jan. 29, 2021

(30) Foreign Application Priority Data
Jan. 31, 2020 (GB) 2001357.9

(51) Int. Cl. G02F 1/1339

(52) U.S. Cl. CPC G02F 1/13396; G02F 1/13394

(57) ABSTRACT

A liquid crystal cell comprising liquid crystal material contained between two plastics film components, wherein the liquid crystal material is interspersed with spacers, wherein (a) the area occupied by spacers is between about 0.25% and about 0.5% of the sum of (a) the area occupied by spacers and (b) the area occupied by the liquid crystal material.

### CLAIM OF PRIORITY

This application claims priority to Great Britain Patent Application No. 2001357.9, dated Jan. 31, 2020.

### FIELD OF THE INVENTION

Spacers are used in the active area of liquid crystal (LC) cells to better achieve a substantially uniform thickness of LC material over the entire active area.

Historically, LC cells were first constructed by containing LC material between glass components; and the construction of LC cells from plastics film components was a later development.

It is not unusual for those working on developing plastics film devices to begin from the technology already well established for glass devices. The inventors for the present application identified a spacer density of 0.6% in glass devices, and believed that an even higher spacer density would be needed for plastics film devices because of a concern about the inherent properties of plastic films making them more susceptible to bowing of the support substrate in regions between spacers. In fact, the inventors for the present application surprisingly found by experiment that good results are achievable with spacer densities as low as 0.25%.

The present invention provides a liquid crystal cell comprising liquid crystal material contained between two plastics film components, wherein the liquid crystal material is interspersed with spacers, wherein (a) the area occupied by spacers is between about 0.25% and about 0.5% of the sum of (a) the area occupied by spacers and (b) the area occupied by the liquid crystal material.

According to one embodiment, the spacers are arranged in a regular or substantially regular hexagonal pattern.

According to one embodiment, the spacers have a cross-sectional diameter of about 20 microns and a height of about 7.5 microns.

According to one embodiment, the spacers have a cross-sectional diameter of greater than 10 microns.

According to one embodiment, the spacers have a cross-sectional diameter of less than 30 microns.

According to one embodiment, the spacers have a cross-sectional diameter in the range of 15 to 25 microns.

According to one embodiment, each of the two plastics film components comprises a single plastics support film having a thickness of about 60 microns.

According to one embodiment, the single plastics film comprises a cellulose triacetate (TAC) film.

According to one embodiment, the cross-sectional diameter of the spacers is greater than the height of the spacers.

There is also hereby provided an electro-optic device comprising one or more liquid crystal cells as described above.

### BRIEF DESCRIPTION OF THE FIGURES

An embodiment of the present invention is described in detail hereunder, by way of example only, with reference to the accompanying drawings, in which:

FIG. 1 illustrates an example of a LC cell for a LC electro-optic device;

FIG. 2 illustrates an example of a spacer pattern for the LC cell of FIG. 1; and

FIG. 3 shows images of backlit views through LC cells having different spacer densities.

### DETAILED DESCRIPTION

Some examples of LC electro-optic devices comprising one or more LC cells include: (i) switchable privacy screens switchable between a high transmissive state (transparent state) in the visible spectrum and a low transmissive state (opaque state) in the visible spectrum; (ii) LC optics devices such as adaptive lens devices having variable focal lengths; and (iii) pixelated LC display devices such as organic liquid crystal display (OLCD) devices using an organic semiconductor for a thin-film-transistor array used to independently control the optical output of each pixel.

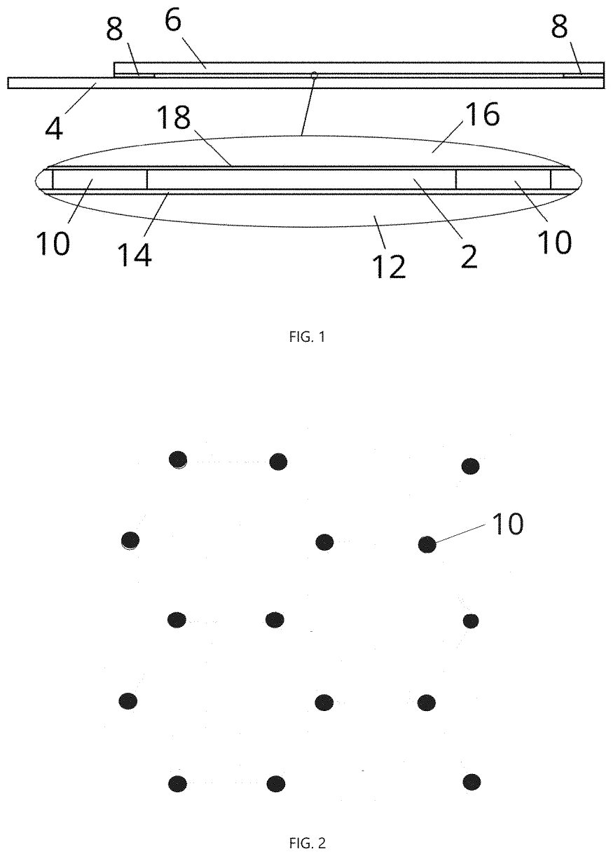

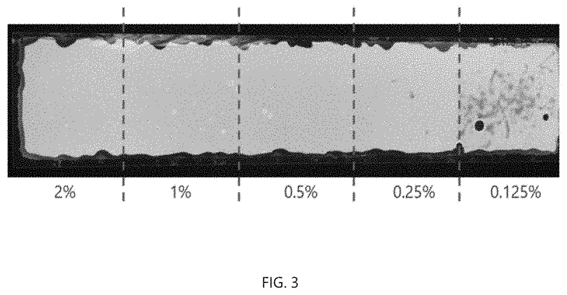

With reference to FIG. 1, an example of a LC cell comprises LC material 2 contained between two plastics film components 4, 6. A sealant/adhesive 8 applied to one or more of the two plastics film components before assembling the LC cell functions to laterally contain the LC material 2 between the two plastics film components 4, 6. The LC material 2 is interspersed with spacer structures 10 over the active area of the LC cell. The spacer structures 10 form an integral part of one or more of the plastics film components 4, 6. The spacer structures 10 may be transparent or black.

Each plastics film component 4, 6 comprises a single plastics support film 12, 16, which provides the primary structural support for the plastics film component 4, 6. On at least one of the support films 12, 16 is formed in situ a pattern of spacer structure material that defines the spacer structures 10. This pattern of spacer structure material is formed in situ on a plastics support film 12, 16 by forming a layer of spacer structure material in situ on the plastics support film 12, 16 (or a precursor thereto), and then patterning the layer in situ on the plastics support film. For example, the spacer structures may comprise a cross-linked polymer material, such as the cross-linked polymer material obtained by UV-activation and post-baking of the negative photoresist material known as SU-8, comprising a solution of the Bisphenol A Novolac epoxy molecule known as the SU-8 molecule and a photo-acid generator. For example: a layer of the negative photoresist material solution is formed in situ on the plastics support film, and dried to remove solvent; the dried layer is exposed to UV radiation to activate the layer selectively in those regions where spacers are to be formed; the exposed layer is subjected to post-baking to promote polymerisation in the activated areas, to thereby form cross-linked polymer material in the activated areas and create a latent solubility pattern within the layer; and the latent solubility pattern is developed using a suitable solvent to create a physical pattern.

For the example of a privacy screen or display device, each plastics support film 12, 16 supports a thin blanket LC alignment layer (not shown) at the working surface of the plastics film component that interfaces with the LC material 2. In this example, the LC alignment layer for the plastics film component(s) including the spacers 10 is formed after forming the spacer pattern 10, but the LC alignment layer has a thickness that is negligible (e.g. 4-40 nm) compared to the height of the spacers 10 (e.g. 7.5 microns). The LC alignment layers control the director of the LC material 2 (orientation of the molecules of the LC material 2) in the absence of an overriding electrical field generated between electrodes forming part of one or both of the plastics film components 4, 6. Each LC alignment layer may, for example, comprise a rubbed polyimide layer.

As mentioned above, at least one of the plastics support films supports a pattern of spacer structure material formed in situ on the plastics support film and defining the array of spacer structures 10. One example of a pattern of spacer structures is shown in FIG. 2. This regular hexagonal pattern of spacer structures 10 comprises substantially circular (circular in the plane of the LC cell, i.e., in the plane of the plastics support films 12, 16) spacer structures 10 having their circle centres located at the vertices of a regular hexagonal tile pattern. For the example of devices (such as pixelated display devices) for which there are non-active areas interspersed between active areas (e.g., a device including a colour filter array comprising colour filter areas in a black matrix), some deviation from a perfectly regular hexagonal pattern may be necessary to advantageously locate the spacer structures 10 in non-active areas (e.g., black matrix areas).

Layers supported by the plastics film components 12, 16 also include one or more layers that define electrical circuitry for electrically controlling one or more optical properties of the LC material 2. For the example of a relatively simple device such as a privacy screen switchable as a whole between transparent and opaque states, the electrical circuitry may simply comprise a blanket electrode 14 formed in situ on one plastics support film 12 and a blanket counter electrode 18 formed in situ on the other plastics support film 16, with connections to switch the voltage across the two blanket electrodes.

For the example of an adaptive LC lens device: one of the plastics support films 12 may support a stack of layers 14 formed in situ on the plastic support film 12, which stack of layers 14 defines, e.g., a set of concentric conductors; and the other plastics support films 16 supports a blanket counter electrode 18 formed in situ on the other plastics support film 16. The stack of layers 14 further defines terminals to apply different voltages between each concentric conductor and the counter electrode 18, and thereby create different refractive index patterns within the LC material 2.

For the example of a pixelated display device: one plastic support film 12 may support a stack of layers 14 that defines an array of pixel electrodes and electrical circuitry (such as active matrix circuitry) for independently addressing each pixel electrode via conductors outside the active display area. One or more counter electrodes may be defined by the same stack 14, or may, e.g., be defined by a conductor layer 18 formed in situ on the other plastics support film 16.

The LC electro-optic device may comprise extra components in addition to one or more LC cells. For the example of a privacy screen or a pixelated display device: the LC electro-optic device additionally at least comprises polariser components on opposite sides of the LC cell.

FIG. 4 shows a comparison of five LC cells with different spacer densities ranging from 0.125% to 2%. Spacer density is defined here as (a) the area occupied by the spacers as a percentage of the sum of (a) the area occupied by spacers and (b) the area occupied by the liquid crystal material. Each LC cell was constructed in the same way, except for the difference in spacer density. The plastics film components 4, 6 each comprised TAC films of 60 micron thickness as primary support films 12, 16; the spacers comprised cross-linked SU-8; and the spacer pattern 10 was a regular hexagonal pattern; and the spacers 10 had a height of 7.5 microns and a cross-sectional diameter of 20 microns. The images of FIG. 4 are backlit views of the undriven cells through polarisers arranged (for test purposes) at 45 degrees to each other on opposite sides of the LC cell. The images show a severe deterioration in LC thickness uniformity at a spacer density of 0.125%, but indicate acceptable levels of LC thickness uniformity even at spacer densities as low as 0.5% and 0.25%.

In the example described above, the spacers have a diameter in the range of between 10 and 30 microns, and more particularly in the range of between 15 and 25 microns. Large spacer diameters can be particularly advantageous when the formation of the above-mentioned LC alignment layer (formed after forming the spacer pattern 10) involves physically rubbing a layer of alignment material in situ over the spacer pattern. Spacers with large diameters facilitate good adhesion and are good at supporting the plastics support films 12, 16 in the desired configuration.

Large spacer diameters can, for example, be particularly advantageous in cells for LC optics devices (such as adaptive lens devices having variable focal lengths), in which the cell gap (and thus the spacer height) can be higher than in other types of LC devices.

In the example described above, the aspect ratio of the spacers (ratio of the diameter of the spacers to the height of the spacers) is greater than 1.

In addition to any modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

What is claimed is:

1. A liquid crystal cell comprising liquid crystal material contained between two plastics film components, wherein the liquid crystal material is interspersed with spacers, wherein (a) the area occupied by spacers is between about 0.25% and about 0.5% of the sum of (a) the area occupied by spacers and (b) the area occupied by the liquid crystal material.

2. The liquid crystal cell according to claim 1, wherein the spacers are arranged in a regular or substantially regular hexagonal pattern.

3. The liquid crystal cell according to claim 1, wherein the spacers have a cross-sectional diameter of about 20 microns and a height of about 7.5 microns.

4. The liquid crystal cell according to claim 1, wherein the spacers have a cross-sectional diameter of greater than 10 microns.

5. The liquid crystal cell according to claim 4, wherein the spacers have a cross-sectional diameter of less than 30 microns.

6. The liquid crystal cell according to claim 5, wherein the spacers have a cross-sectional diameter in the range of 15 to 25 microns.

7. The liquid crystal cell according to claim 1, wherein each of the two plastics film components comprises a single plastics support film having a thickness of about 60 microns.

8. The liquid crystal cell according to claim 7, wherein the single plastics film comprises a cellulose triacetate (TAC) film.

9. The liquid crystal cell according to claim 1, wherein the cross-sectional diameter of the spacers is greater than the height of the spacers.

10. An electro-optic device comprising one or more liquid crystal cells according to claim 1.
